(19) United States
(12) Patent Application Publication
(10) Pub. No.: US 2012/0167709 A1
(43) Pub. Date: Jul. 5, 2012

(54) Length adjustable bicycle crank

(76) Inventors: Kung-Cheng Chen, Taichung (TW); Walter Luke, Diamond Bar, CA (US)

(21) Appl. No.: 12/983,329

(22) Filed: Jan. 3, 2011

(51) Int. Cl. B62M 3/02

(52) U.S. Cl. 74/594.2

(57) ABSTRACT

A crank system mounted to a drive sprocket of a bicycle includes a crank arm secured to the drive sprocket and disposed at both sides thereof, the crank arm having two bent ends; and two telescopic assemblies each comprising a bar having one end fixedly secured to either end of the crank arm, the bar having a cross section of polygon, the bar including a plurality of longitudinal notches, a sliding tube slidably put on the bar, the sliding tube including a surface opening communicating with the bar, and a pivotal lock member in the surface opening, the lock member being adapted to either dispose in one of the notches in a locked position of the telescopic assembly or clear the notch in a unlocked position of the telescopic assembly. This length adjustable bicycle crank system can save force when pedaling.

### BACKGROUND OF THE INVENTION

1. Field of Invention

The invention relates to labor saving bicycles and more particularly to a bicycle having two cranks each adapted to adjust the length (e.g., length increase) so as to save force when pedaling.

2. Description of Related Art

A bicycle is a vehicle having two wheels placed one behind the other and mounted on a frame which carries a saddle for a rider. Between the wheels is a crank-axle which the rider drives by means of the cranks and pedals, and its motion is transmitted to the rear wheel by a chain passing over two drive sprockets, one fixed on the crank-axle and the other on the hub of the rear wheel. The rear wheel is usually so arranged that it can turn, when the bicycle is running by its own momentum, independently of the chain and pedals. The front wheel is mounted in a fork having its two upper ends brazed into the “crown,” to which also the lower end of the steering tube is brazed. The steering tube is mounted by ball bearings in the socket tube, which forms the forward portion of the rear-frame.

It is understood that the magnitude of torque is equal to force applied times length of crank arm. This means that an appropriate increase of the length of crank arm can save pedaling force in terms of bicycle riding. However, most typical bicycles do not have adjustable crank arms and therefore, force applied to the pedals cannot be saved while riding.

There is type of labor saving bicycle commercially available. The characteristic of the bicycle is that length of crank arm can be adjusted automatically, i.e., the length of crank arm is prolonged automatically via a cam and ball bearing based mechanism when pedaling or shortened automatically via the mechanism when not pedaling. Therefore, the purpose of saving force is achieved.

However, a number of drawbacks have been found in the typical labor saving bicycle. Its components are complicated and it is prone to malfunction. Its operation is inconvenient. It is not a lightweight mechanism and thus it can increase the weight of the bicycle greatly. This compromises the desired purpose of labor saving when pedaling. Therefore, the need for improvement still exists.

### SUMMARY OF THE INVENTION

It is therefore one object of the invention to provide a crank system mounted to a drive sprocket of a bicycle, comprising a crank arm secured to the drive sprocket and disposed at both sides thereof, the crank arm having two bent ends; and two telescopic assemblies each comprising a bar having one end fixedly secured to either end of the crank arm, the bar having a cross section of polygon, the bar including a plurality of longitudinal notches, a sliding tube slidably put on the bar, the sliding tube including a surface opening communicating with the bar, and a pivotal lock member in the surface opening, the lock member being adapted to either dispose in one of the notches in a locked position of the telescopic assembly or clear the notch in a unlocked position of the telescopic assembly.

The above and other objects, features and advantages of the invention will become apparent from the following detailed description taken with the accompanying drawings.

### BRIEF DESCRIPTION OF THE DRAWINGS

FIG. 1 is a perspective view of two telescopic assemblies, two crank arms, and two pedals of a bicycle crank system mounted to a drive sprocket according to the invention;

FIG. 2 is an exploded view of FIG. 1;

FIG. 3 is a front view in part section of FIG. 1; and

FIGS. 4 and 5 are sectional views taken along lines X-X and Y-Y of FIG. 3 respectively.

### DETAILED DESCRIPTION OF THE INVENTION

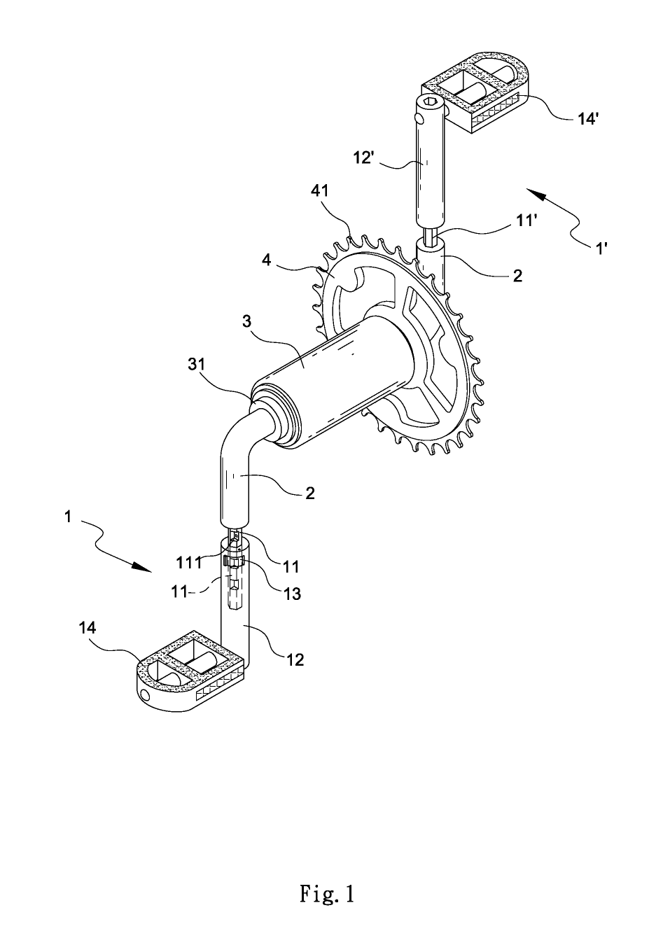

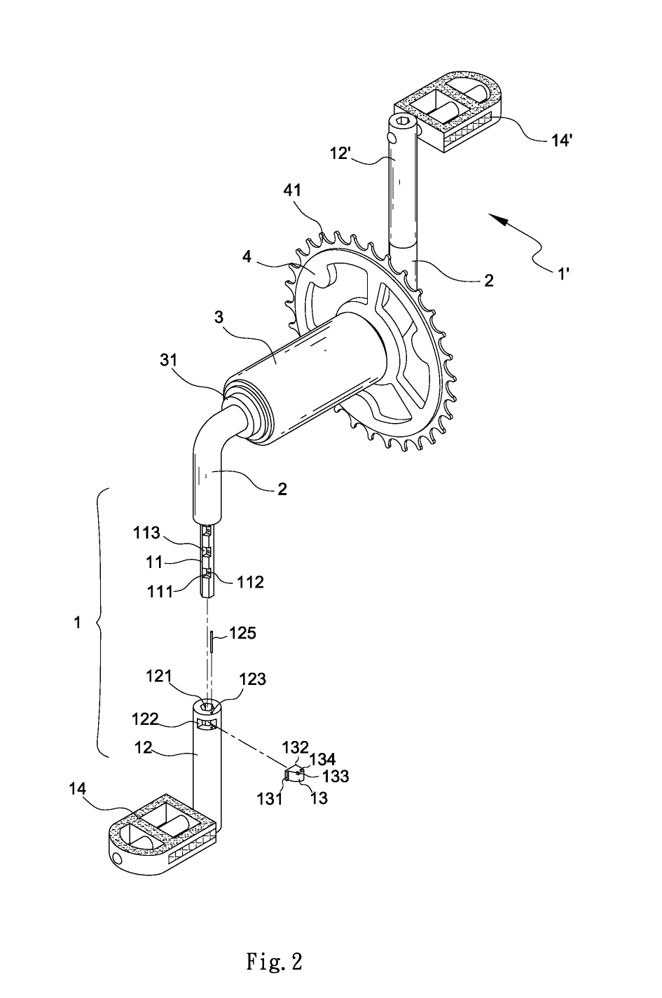

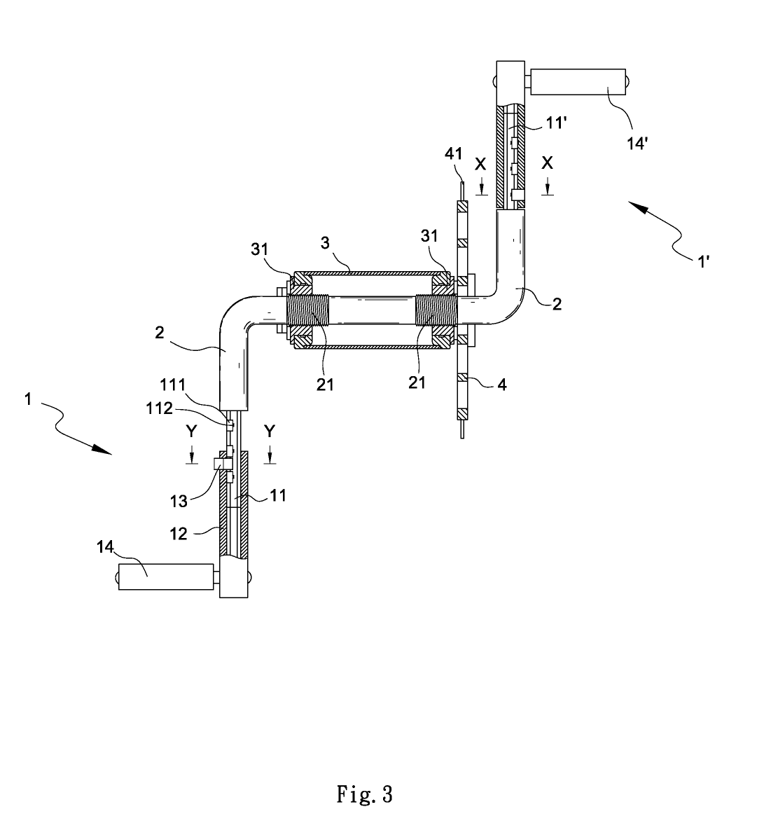

Referring to FIGS. 1 to 5, a crank system mounted to a drive sprocket of a bicycle in accordance with the invention is discussed in detail below.

Some components of the crank system (e.g., telescopic assemblies 1, 1′ each including a bar 11 (or 11′) and a sliding tube 12 (or 12′)) and pedals 14, 14′ are arranged symmetrically at both sides of a drive sprocket 4 and are mirror images each other. Thus, only telescopic assembly 1, pedal 14, and other components at one side of the drive sprocket 4 will be described hereinafter.

A telescopic assembly 1 comprises a bar 11 and a sliding tube 12 slidably put on the bar 11. One end of the bar 11 is fixedly secured to one of two bent ends of a crank arm 2. Two spaced externally threaded sections 21 are provided on the horizontal part of the crank arm 2. One externally threaded section 21 is secured to a central crank support of the drive sprocket 4 having a series of teeth 41 therearound. A cylindrical sleeve 3 comprises two nuts 31 in which one nut 31 is threadedly put on one externally threaded section 21 and the other nut 31 is threadedly put on the other externally threaded section 21 proximate the bent point of the crank arm 2. As a result, the sleeve 3 is fastened.

The bar 11 has a cross section of polygon (e.g., hexagon as shown). A plurality of notches 111 are formed longitudinally along length of the bar 11 and are at the same side as a pedal 14. The notch 111 has a 90-degree corner 113 and a magnet 112 proximate to the corner 113. The magnet 112 is embedded on one inner surface of the notch 111. Inner surfaces including the inner surface with the embedded magnet 112 are relatively flush.

The bore 121 of the sliding tube 12 has a cross section of polygon (e.g., hexagon as shown). The bar 11 can be complimentarily inserted into the bore 121. The sliding tube 12 has an opening 122 on a cylindrical surface. The opening 122 communicates with the bore 121. The mouth of the opening 122 is about 90-degree wide. A through hole 123 is provided on one end of the sliding tube 12 facing the crank arm 2 and communicates with the opening 122. The other end of the sliding tube 12 is fixedly secured to an axle of the pedal 14.

The telescopic assembly 1 further comprises a pivotal lock member 13 having a cross section shaped as a quadrant. The lock member 13 comprises a through hole 134 on a top surface so that a pivot pin 125 may be inserted through the through holes 123, 134 into a hole (not numbered) on the bottom edge of the opening 122 to pivotably secure the lock member 13 to the sliding tube 12. Top end of the pivot pin 125 is flush with one end of the sliding tube 12. The lock member 13 further comprises a projection 131 at an edge of an outer surface and a 90-degree corner 132. The projection 131, the 90-degree corner 132, and the through hole 134 are substantially at three corners or angles of the lock member 13. The lock member 13 further comprises a steel 133 embedded on an inner surface.

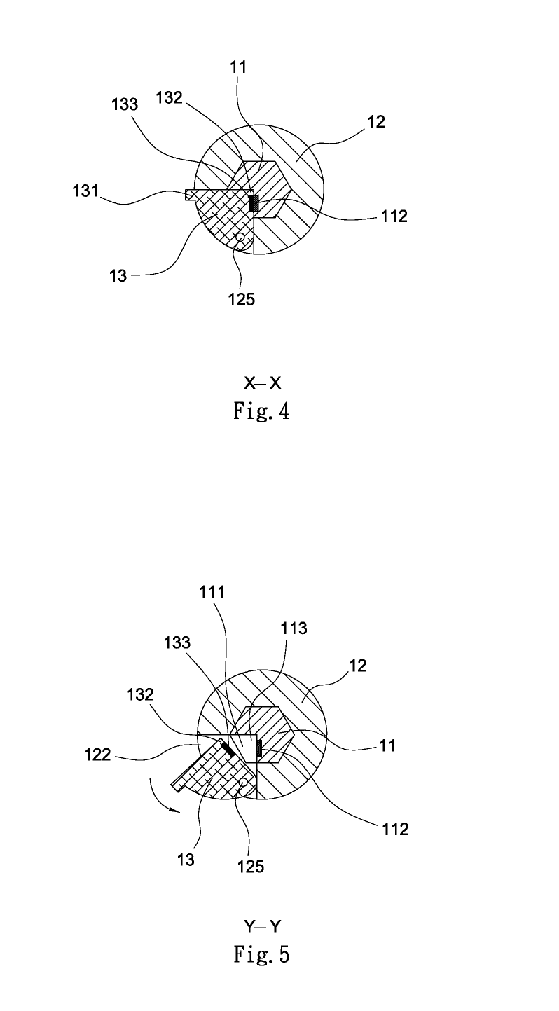

Prior to riding a bicycle, a rider may cause the lock member 13 to clear the notch 111 by holding and pivotably pulling the projection 131 outward and then align the opening 12 with one of the notches 111 by sliding the sliding tube 12 with respect to the bar 11 (see FIG. 5). Preferably, the notch 111 distal the crank arm 2 is chosen because it can increase the distance from the pedal 14 to the crank arm 2 (i.e., increasing torque and saving pedaling force). The steel 133 will be engaged with the magnet 112 (i.e., magnetically attracted each other) when the lock member 13 is pivoted to completely close the opening 122 and partially insert into the notch 111 (see FIG. 4). At this position, the lock member 13 is temporarily fastened.

It is understood that an increase of the length of a lever can decrease the force applied to one end of the lever (i.e., labor saving) when turning an object secured to the other end of the lever if the torque is a constant. Hence, an increase of the distance from the pedal 14 to the crank arm 2 (e.g., increase of the total length of the bar 11 and the sliding tube 12) by adjusting in a manner described above can save labor when pedaling.

While the invention has been described in terms of preferred embodiments, those skilled in the art will recognize that the invention can be practiced with modifications within the spirit and scope of the appended claims.

What is claimed is:

1. A crank system mounted to a drive sprocket of a bicycle, comprising:
a crank arm secured to the drive sprocket and disposed at both sides thereof, the crank arm having two bent ends; and
two telescopic assemblies each comprising a bar having one end fixedly secured to either end of the crank arm, the bar having a cross section of polygon, the bar including a plurality of longitudinal notches, a sliding tube slidably put on the bar, the sliding tube including a surface opening communicating with the bar, and a pivotal lock member in the surface opening, the lock member being adapted to either dispose in one of the notches in a locked position of the telescopic assembly or clear the notch in a unlocked position of the telescopic assembly.

2. The crank system of claim 1, wherein the notch has a corner and a magnet embedded on an inner surface of the notch.

3. The crank system of claim 1, wherein the lock member comprises a through hole on a top surface, and the sliding tube further comprises a through hole on one end facing one end of the crank arm, the through hole communicating with the surface opening, and a pivot pin pivotably inserted into the through holes to pivotably fasten the lock member in the surface opening.

4. The crank system of claim 2, wherein the lock member further comprises a projection at an edge of an outer surface, a corner complimentary to the corner of the notch, and a steel embedded on an inner surface, the steel being adapted to magnetically engage with the magnet when the lock member is pivoted to completely close the surface opening and partially insert into the notch.

5. The crank system of claim 1, further comprising a rotatable pedal secured to the other end of the sliding tube distal the bar.

6. The crank system of claim 1, wherein the drive sprocket has a series of teeth therearound, and wherein the crank arm comprises two spaced externally threaded sections between both ends thereof, and further comprising a cylindrical sleeve including two nuts threadedly secured to the externally threaded sections respectively for mounting the sleeve on the crank arm.
